(19) United States
(12) Patent Application Publication
(10) Pub. No.: US 2011/0250370 A1
(43) Pub. Date: Oct. 13, 2011

(54) COMPOSITION AND METHOD OF PRODUCING AN ELASTIC BAND, SHEET, STRIP OR FIBRILLATED FILM

(75) Inventors: Daniel Arnaud, Saint Etienne (FR); Francois-Xavier Damour, Lyon (FR)

(73) Assignee: SOCIETE PLYMOUTH FRANCAISE, FEYZIN (FR)

(21) Appl. No.: 12/376,504

(22) PCT Filed: Aug. 1, 2007
(86) PCT No.: PCT/FR2007/001332

§ 371 Date: Apr. 15, 2009

(30) Foreign Application Priority Data
Aug. 7, 2006 (FR) 0607192
Sep. 15, 2006 (FR) 0608099

(51) Int. Cl. B32B 1/08; C08K 5/20; B32B 5/00; B29C 47/08; B29C 70/64; C08L 53/02; C08L 23/16

(52) U.S. Cl. 428/35.7; 524/505; 524/229; 264/151; 264/113; 428/195.1

(57) ABSTRACT

This composition comprises at least two thermoplastic elastomers belonging to two separate classes of thermoplastic elastomer, selected from the following three classes: a thermoplastic elastomer of polyethylene type with a partially or totally vulcanized rubber phase (TPV), an olefinic thermoplastic elastomer of ethylene-propylene copolymer type (TPO), and a thermoplastic elastomer based on styrene (TPE); and at least one compatibilizer and/or surfactant.

The present invention relates to a composition and to a method for producing an elastic band, sheet, strip or fibrillated film.

### BACKGROUND OF THE INVENTION

At the present time, fibrillated films and bands are made of elastomer or of rubber.

Elastomers or rubbers are polymers that can be stretched by several times their length and return more or less to their initial shape with a small permanent set, the elongation after extension being less than 10% of their initial size. Their “deformability” is connected with the fact that there is a very substantial amorphous phase characterized by an extremely low glass transition temperature (generally below −40° C.).

The fibrillated films are used in a number of fields, and in particular in:
making garments (to elasticate underwear, swimsuits, etc.);
to elasticate fitted sheets;
in disposable hygiene products (to elasticate nappy pants, etc.) and in personal protective equipment (PPI) (as the elastic to hold respiratory masks, bouffant caps, overshoes, etc., in place).

The rubber used to make the fibrillated films is generally natural rubber (NR) or synthetic polyisoprene (IR) commonly known as synthetic rubber.

The manufacturing cycle for the fibrillated films is complex and consumes a great deal of energy. It includes the steps involving:
creating a rubber composition,
extruding the composition into a strip form to feed into a calender,
calendering the extruded strip,
vulcanizing the calendered film on a roll, it being possible for the vulcanizing cycle to last in excess of one hour at a temperature generally of above 130° C., the roll being placed in an autoclave and the film being covered with a plastic jacket,
cutting the film into fibrillated films.

The fibrillated films thus obtained are essentially characterized by:
an elongation at break in excess of 500%,
a thickness generally ranging between 0.1 mm (the lowest value achievable by calendering) and 1 mm,
elastic springback and a tensile set (TS) of less than 15%,
a modulus,
and a high economic cost (approximately 5 euro/kg).

Rubber bands are, for their part, used in the following main fields:
to elasticate garments (waistbands, sleeves, etc.);
as elastic for holding disposable respiratory masks in place.

There are two techniques used to manufacture these bands:
the extrusion of sleeve tubes, which are then vulcanized continuously and then cut into bands,
the creation of sleeve tubes by dip coating, followed by continuous vulcanization and cutting into bands. This second technology entails the use of a latex by way of a raw material, lattices being based on natural rubber.

The bands obtained have mechanical and chemical properties similar to those of the fibrillated films.

However, it should be noted that, at the present time, the bands are made only from natural rubber because bands made of synthetic rubber are too expensive.

### DESCRIPTION OF THE PRIOR ART

The fibrillated films and bands currently on the market have the following disadvantages:
they cannot be hot-welded;
they cannot be used to create assemblies by ultrasonic or microwave welding to other materials;
they are not recyclable;
in the case of products based on natural rubber, they contain allergenic proteins. These proteins are present in the latex from the rubber tree plant and cannot be separated from the elastomer;
the processing techniques consume vast amounts of energy (because they involve several heating and cooling cycles);
very fine thicknesses (of below 0.01 mm) cannot be achieved for fibrillated films. This limitation is associated with the calendering technology;
fine thicknesses (of below 0.5 mm) cannot be achieved for the bands. This limitation is associated with the technique used to obtain the sleeve tubes.

The last few years have seen the development of a new category of polymers known as thermoplastic elastomers. The main families of thermoplastic elastomers are TPVs (thermoplastic vulcanizate elastomers containing a partially or completely vulcanized rubber phase), TPOs (thermoplastic olefins), TPEs (styrene-based thermoplastic elastomers) and TPUs (thermoplastic urethane elastomers).

These products have mechanical and chemical properties both of elastomers and of thermoplastics.

Thus, these products can be stretched by several times their length and return more or less to their initial shape with a very small permanent set (like elastomers) and can be liquefied when heated and returned to a solid state upon subsequent cooling (like thermoplastics).

As a result, thermoplastic elastomers can be hot-welded and can be used to create assemblies by ultrasonic or microwave welding to other materials.

However, TPVs lead to products that exhibit a creep and a TS that are too high for the intended applications. These products are generally obtained by “dispersion” within the polypropylene chains of elements of the EPDM type. These blocks of EPDM may, however, be replaced by elements of a different chemical nature such as hydrogenated styrene-based block copolymers (of the HSBC type).

Likewise, TPOs lead to products that have a great deal of residual stickiness and which are incompatible with the intended applications. They also exhibit strength at the maximum service temperature that is too low for the intended applications. The method of manufacturing these products generally involves catalysis of the metallocene type. TPOs can be divided into three categories: ethylene/octene copolymers, ethylene/butene copolymers and ethylene/propylene/diene copolymers.

Finally, TPEs cannot achieve the desired fine thicknesses and exhibit a high level of creep and low retention.

These TPEs are predominantly of the SEBS (styrene/ethylene/butadiene/styrene) block copolymer type, of the SIS (styrene/isoprene/styrene) block copolymer type, or of the SBS (styrene/butadiene/styrene) block copolymer type. These TPEs may also be combined with other polymers and compositions based on crosslinkable or partially crosslinked TPEs and TPUs are described in documents EP 1 086 991, US 2003/0017223, U.S. Pat. No. 5,936,037 and U.S. Pat. No. 5,910,540. These compositions make it possible to create products of the “partially crosslinked thermoplastic elastomer” type which have a level of properties similar to those of TPVs.

As a result, these thermoplastic elastomers cannot be used to obtain fibrillated films and bands that have mechanical and chemical properties similar to those of the fibrillated films or bands made from elastomers.

The present invention intends therefore to remedy these disadvantages.

The technical problem underlying the invention is to provide a composition for producing a fibrillated film or a band that is of good value and exhibits mechanical and chemical properties similar to those of a fibrillated film or of a band made from elastomers, whilst at the same time being hot-weldable, capable of being assembled by microwave or ultrasonic welding, is recyclable, and contains no allergenic proteins.

### SUMMARY OF THE INVENTION

To this end, the present invention relates to a composition for producing in particular an elastic band, sheet, strip or fibrillated film, characterized in that it comprises:
at least two thermoplastic elastomers belonging to two different families of thermoplastic elastomer chosen from the following three families:
   a thermoplastic elastomer of the polyethylene type with a partially or fully vulcanized rubber phase (TPV),
   a thermoplastic olefin (TPO) elastomer of the ethylene-propylene copolymer type,
   a styrene-based thermoplastic elastomer (TPE),
   at least one compatibilization and/or surface agent.

Although they are available on the market, these various products have never yet been combined with one another because they were deemed to be somewhat incompatible. The only combinations hitherto achieved describe a TPE/TPO alloy in which the TPE is a styrene block copolymer and the TPO is a polyolefin originating from ethylene polymerized with a metallocene catalyst. This alloy is covered by document WO 01/25331.

Now, the applicant company has discovered surprisingly that combining at least two of the aforementioned three types of thermoplastic elastomer makes it possible to obtain fibrillated films or bands that exhibit mechanical and chemical properties similar to those of fibrillated films or bands made from elastomers.

Further, the presence of thermoplastic elastomers in the composition makes it possible to obtain fibrillated films or bands that can be hot-welded, can be assembled by microwave or ultrasonic welding, can be recycled, and do not contain any allergenic protein.

The presence of a TPV gives the composition mechanical properties (a modulus) of the rubber type. The presence of a TPO essentially gives the composition elasticity. The presence of a TPE gives the composition a retention comparable with rubber-based compositions.

The contribution made by the three families of thermoplastic elastomer can be summarized as follows:

| Property | TPV | TPO | TPE |
|---|---|---|---|
| Rubber modulus | X | X | |
| Retention | | X | X |
| Low TS | | X | X |
| Temperature resistance | X | | X |
| Resistance to light | X | X | |

The choice of the precise type of each thermoplastic elastomer that makes up the composition is made on the basis of the desired mechanical properties.

Thus, in particular, the hardness of each thermoplastic elastomer is chosen so that the composition has a hardness ranging between 30 and 60 shore A, and preferably ranging between 40 and 50 shore A. For preference, the various thermoplastic elastomers have a hardness of the order of 45 shore A.

It should be noted that the “degree of rubber phase” of each thermoplastic elastomer has a direct influence on the properties of the composition. Specifically, the greater the “rubber” phase, the more similar the properties of the thermoplastic elastomer are to those of vulcanized elastomers.

Likewise, the “degree of plastic phase” of each thermoplastic elastomer has a direct influence on the properties of the composition. Specifically, the greater the “plastic” phase, the easier the composition is to shape using extrusion.

As a result, the “degree of rubber phase” and the degree of plastic phase” of each thermoplastic elastomer are chosen according to the desired mechanical properties of the composition.

In addition, the very nature of the plastic phases also has a great influence over the properties of the composition. Specifically, the use of plastic phases in which the crystallinity is high improves the mechanical properties of the composition.

It should be noted that the compatibilization and/or surface agents guarantee good “extrudability” and a lack of residual stickiness of the composition.

### DESCRIPTION OF THE PREFERRED EMBODIMENTS

For preference, the composition comprises at least three separate thermoplastic elastomers chosen from the following families: TPV, TPO and TPE.

According to a first example of the composition, this composition may include:
25 parts of TPV,
25 parts of TPO,
50 parts of TPE,
1.5 parts of compatibilization agent(s), the parts being expressed by weight.

According to this example, the TPV may include a rubber phase of the ethylene-propylene-diene terpolymer (EPDM) type, the TPO may have a high polypropylene content (of the order of 80 wt %) and the TPE may be a styrene-based polymer of the SES, SEBS type. For preference, the compatibilization element is based on polyamide prepolymer or on polyamide oligomer.

According to a second example of the composition, this composition may include:
10 to 50 parts of TPV,
10 to 50 parts of TPO,
10 to 300 parts of TPE,
0.1 to 5 parts of compatibilization agent(s), the parts being expressed by weight.

According to this example, the TPV may include a rubber phase of the partially or fully vulcanized ethylene-propylene-diene terpolymer (EPDM) type, the TPO may be of the EPM type with isotactic polypropylene sequences obtained by polymerization with catalysis of the metallocene type, and the TPE may be a styrene-ethylene/butylene-styrene block copolymer. For preference, the compatibilization agent is based on polyamide prepolymer or on polyamide oligomer.

A method for producing an elastic band or fibrillated film will now be described. This production method comprises the steps involving:
creating a composition as described in the above description,
extruding the composition into a film or a sleeve tube,
stretching the extruded film or sleeve tube in its direction of use,
cutting the film or the sleeve tube into fibrillated films or bands respectively.

Unlike the methods of the prior art for producing fibrillated films or bands, the production method according to the invention does not include any step of vulcanizing the extruded film or sleeve tube.

As a result, the production method according to the invention involves fewer heating and cooling cycles than the methods of the prior art. The result of this then is that the costs of manufacturing the fibrillated films and bands are greatly reduced.

The production method involves a step of stretching the extruded film or sleeve tube in its direction of use in order to orient the chains of the plastic phase and thus greatly reduce the “disruptive” effect they have on the TS and to focus the elastic properties into the rubber phase.

This stretching step therefore makes it possible to reduce the TS and thus get closer to the properties of vulcanized elastomers.

Advantageously, the stretching step takes place directly after the extrusion step.

The stretching may be performed transversely and/or longitudinally with respect to the direction of extrusion of the film or of the sleeve tube.

According to a first embodiment of this method, when the desire is to produce a fibrillated film, the composition is extruded in the form of a film through a flat die then the extruded film is stretched longitudinally in a drawing oven. This drawing oven comprises a region in which the extruded film is heated to a temperature generally of between 170 and 190° C. Between the entrance and the exit of the oven, two series of two parallel rolls regulate the degree of stretch; the exit speed of the film being, for example, twice the speed at which the film enters the oven, thus allowing the film to be stretched by 100%. Of course, the degree of stretch could also range between 100 and 150%. The coefficients of stretch are defined according to the intended properties and constituent ingredients of the composition.

According to a first alternative of this method, the stretching step involves stretching the extruded film longitudinally by blowing it as it leaves the extrusion die.

In these two embodiments of the production method, the fibrillated films are obtained by cutting the extruded and stretched film longitudinally.

According to a second alternative of this method, when the desire is to create a band, the composition is extruded into a sleeve tube through a cylindrical die and then the extruded sleeve tube is stretched radially by inflating it as it leaves the extrusion die.

The fibrillated films or bands obtained according to these production methods may have the following properties:
a thickness of less than 0.1 mm;
a modulus of the order of 10 to 20 MPa at 300% elongation;
be transparent or translucent.

It must be noted that a band obtained according to the second alternative of the production method with a degree of radial inflation of 250% and with a composition as defined in the first example, has the following mechanical properties:
Modulus at 500%: 1.5 MPa,
TS at 200%: 10%,
Retention strength at 60% after extension to 300% (for band sizes of 0.4×6 mm): 1.5 N.

These values are similar to those obtained with bands made of vulcanized rubber.

According to the various alternative forms of the production method which have been described hereinabove, it is also possible to obtain elastic bands or fibrillated films with an elongation of 500% with a modulus of 10 to 20 MPa. This means that it is advantageous to use such fibrillated films particularly in nappy pants in so far as the fibrillated films employed have a shorter initial length and a lower weight than the known elastic items that are made in particular of elastane.

It is also possible to produce complexes comprising a film or sleeve tube obtained from a composition such as that described hereinabove and a discontinuous support consisting of parallel threads, rods or paint-like binders which are inelastic or have an elasticity lower than that of the film or of the sleeve tube and which are independent of one another.

Advantageously, the support has within its composition a water retention agent and/or “energy regulating” agents.

According to an alternative, the support has within its composition microcapsules capable of supporting physico-chemical agents such as anti-allergenic creams for the skin or any other active ingredient.

For preference, the support consists of textile threads (for example: polyester threads, PVA (polyvinyl alcohol) threads or polyamide threads), rods (rods of nonwovens or polymers) or paint-like binders.

The method of obtaining these complexes comprises a step involving continuously depositing the film or the sleeve tube onto the threads, rods or paint-like binders while it is being extruded or depositing the threads, rods or paint-like binders on the film or the sleeve tube while it is being extruded.

The objective of these depositions is to “block” the elasticity of the film or sleeve tube based on thermoplastic elastomers in one direction and thus obtain an end product (elastic strip, band or fibrillated film) that is elastic in just one direction.

The product thus produced may then provide strengthening in the “inelastic” direction and elastication in the other direction.

Advantageously, the threads, rods or paint-like binders are deposited longitudinally or transversely with respect to the direction of extrusion of the film.

As goes without saying, the invention is not restricted only to the compositions described hereinabove by way of examples but on the contrary encompasses all embodiment variants thereof.

Thus in particular, the composition could equally comprise a surface agent such a lubricant based on silica or on polyamide mounted on a polymer base. The composition could further comprise an agent allowing adhesion to glass, such as silanes or polyvinyl butyral. In addition, the use of other types of polymer within the composition may be conceivable: ethylene/vinyl acetate copolymers may, for example, be incorporated into the composition in order to confer special properties such as transparency, biocompatibility, or specific mechanical properties. Furthermore, the degree of radial inflation could range between 200 and 300%.

1. A composition for producing in particular an elastic band, sheet, strip or fibrillated film, wherein it comprises:
at least two thermoplastic elastomers belonging to two different families of thermoplastic elastomer chosen from the following three families:
a thermoplastic elastomer of the polyethylene type with a partially or fully vulcanized rubber phase (TPV),
a thermoplastic olefin (TPO) elastomer of the ethylene-propylene copolymer type,
a styrene-based thermoplastic elastomer (TPE),
at least one compatibilization and/or surface agent.

2. The composition as claimed in claim 1, wherein the composition comprises at least three separate thermoplastic elastomers chosen from the following families: TPV, TPO and TPE.

3. The composition as claimed in claim 1, wherein the TPV has a rubber phase of the EPDM type.

4. The composition as claimed in claim 1, wherein the TPO includes a rubber phase of the polybutadiene type.

5. The composition as claimed in claim 1, wherein the TPE is based on styrene polymers of the SES, SEBS type.

6. The composition as claimed in claim 1, wherein the compatibilization agent is based on a polyamide prepolymer or on a polyamide oligomer.

7. The composition as claimed in claim 1, wherein the surface agent is a lubricant based on silica or on polyamide mounted on a polymer base.

8. The composition as claimed in claim 1, wherein the composition includes:
25 parts of TPV,
25 parts of TPO,
50 parts of TPE,
1.5 parts of compatibilization agent(s), the parts being expressed by weight.

9. The composition as claimed in claim 1, wherein the composition includes:
10 to 50 parts of TPV,
10 to 50 parts of TPO,
10 to 300 parts of TPE,
0.1 to 5 parts of compatibilization agent(s), the parts being expressed by weight.

10. The composition as claimed in claim 1, wherein the hardness of each thermoplastic elastomer is chosen such that the composition has a hardness of between 30 and 50 shore A, and preferably of between 40 and 50 shore A.

11. A method for producing an elastic fibrillated film or band, wherein it comprises the steps involving:
creating a composition as claimed in claim 1,
extruding the composition into a film or a sleeve tube,
stretching the extruded film or sleeve tube in its direction of use,
cutting the film or the sleeve tube into fibrillated films or bands respectively.

12. The method of producing a fibrillated film or band as claimed in claim 11, wherein the stretching step takes place directly after the extrusion step.

13. The method of producing a fibrillated film or band as claimed in claim 11, wherein the stretching is performed transversely and/or longitudinally with respect to the direction of extrusion of the film or of the sleeve tube.

14. The method of producing a fibrillated film or band as claimed in claim 13, wherein the stretching step involves stretching the extruded film longitudinally in a drawing oven.

15. The method of producing a fibrillated film or band as claimed in claim 13, wherein the stretching step involves stretching the extruding film longitudinally by blowing it as it leaves the extrusion die.

16. The method of producing a fibrillated film or band as claimed in claim 13, wherein the stretching step involves stretching the extruded sleeve tube radially by inflating it as it leaves the extrusion die.

17. The method of producing a fibrillated film or band as claimed in claim 13, wherein the degree of stretch ranges between 100 and 150%.

18. The method of producing a fibrillated film or band as claimed in claim 16, wherein the degree of stretch ranges between 200 and 300%.

19. The method of producing a fibrillated film or band as claimed in claim 11, wherein the fibrillated film or the band obtained has a thickness of less than 0.1 mm.

20. The method of producing a fibrillated film or band as claimed in claim 11, wherein the fibrillated film or the band obtained has a modulus of the order of 10 to 20 MPa at 500% elongation.

21. The method of producing a fibrillated film or band as claimed in claim 11, wherein the fibrillated film or the band obtained is transparent or translucent.

22. The method of producing a fibrillated film or band as claimed in claim 11, wherein the fibrillated film or the band adheres to glass.

23. A complex comprising a film or a sleeve tube obtained from a composition as claimed in claim 1 and a discontinuous support consisting of parallel threads, rods or paint-like binders which are inelastic or have an elasticity lower than that of the film or of the sleeve tube and which are independent of one another.

24. The complex as claimed in claim 23, wherein the support has within its composition a water retention agent and/or “energy regulating” agents.

25. The complex as claimed in claim 23, wherein the support has within its composition microcapsules capable of supporting physico-chemical agents such as anti-allergenic creams for the skin or any other active ingredient.

26. A method for obtaining the complex as claimed in claim 23, wherein it comprises a step involving continuously depositing the film or the sleeve tube onto the threads, rods or paint-like binders while it is being extruded or in depositing the threads, rods or paint-like binders on the film or the sleeve tube while it is being extruded.
